(19) United States
(12) Patent Application Publication
(10) Pub. No.: US 2011/0241500 A1
(43) Pub. Date: Oct. 6, 2011

(54) DRIVE TRAIN FOR A MOTOR VEHICLE

(75) Inventors: Martin Lamke, Ravensburg (DE); Oliver Schell, Ravensburg (DE); Rayk Hoffmann, Friedrichshafen (DE); Thomas Gnandt, Horgenzell (DE); Wolfgang Irlbacher, Tettnang (DE)

(73) Assignee: ZF FRIEDRICHSHAFEN AG, Friedrichshafen (DE)

(21) Appl. No.: 13/133,533

(22) PCT Filed: Nov. 18, 2009
(86) PCT No.: PCT/EP09/65352

§ 371 Date: Jun. 8, 2011

(30) Foreign Application Priority Data
Dec. 10, 2008 (DE) 10 2008 054 475.2

(51) Int. Cl. H02K 7/12

(52) U.S. Cl. 310/75 D

(57) ABSTRACT

A drive train for a motor vehicle which comprises of at least a rotatable drive shaft (3) and an electric motor (10) which has an enclosure mounted stator (11) and a rotatable rotor (12) which is coupled with the drive shaft (3). The rotor (12) is designed as at least a two part rotor in which the first rotor part (12A) is directly coupled with the drive shaft (3) and the second rotor part (12B) can be directly driven by the stator (11) and the first rotor part (12A) is tiltable coupled with the second rotor part (12B) for a torque transfer. The second rotor part (12B) is supported, for rotation, by an enclosure mounted rotor bearing (13) which is aligned with reference to the stator (11).

This application is a National Stage completion of PCT/EP2009/065352 filed Nov. 18, 2009, which claims priority from German patent application serial no. 10 2008 054 475.2 filed Dec. 10, 2008.

### FIELD OF THE INVENTION

The invention relates to a drive train for a motor vehicle which has at least a rotatable drive shaft and an electric motor. The electric motor comprises a stator fixed to an enclosure and at least of a two-part designed rotor, whereby the first rotor part is directly coupled with the drive shaft and the second rotor part can be directly driven through the stator. The first rotor part is coupled with the second rotor part for a torque transfer and they can be tilted against each other.

### BACKGROUND OF THE INVENTION

Known from the DE 196 31 384 C1 is a drive train with a two part rotor in which a vibration isolation, which prevents significantly transfer of the generated torque variations on the drive side, is positioned between the rotor parts. The drive train also has a driving motor designed as a combustion engine, where the crankshaft is directly connected, via a carrier, with the rotor part which can be driven by the stator. The vibrations, known to be generated by such a driving motor, are therefore directly transferred to the electric motor, thus causing potentially deviations of the rotor direction with reference to the stator, which may have an impact in regard to the performance of the electric motor.

EP 1 243 788 A1 teaches an additional drive train for a motor vehicle, whereby a rotor of an electric motor is designed as a one-piece part and which is pivoted positioned via a rotor bearing fixed to an enclosure. Also, the rotor is directly coupled with a drive shaft of a countershaft transmission, pivotable supported via two shaft bearings in an enclosure. Thus, the drive shaft is effectively and overdefined statically supported via three bearings, meaning via the two shaft bearings and the rotor bearing. It can cause, when operating the drive train and when the drive shaft is elastically bent, due to torque transfer from the drive shaft to the lay shaft of the transmission, creating also tilting forces and a heavy mechanical load for the rotor bearing.

In addition, a motor vehicle drive train with an electric motor rotor that self adjusts its positioning, even under tumbling movements of a drive shaft, with reference to a stator configuration of the electric motor, is known through the DE 199 43 037 A1. The rotor configuration is connected with the drive shaft via an elastic coupling configuration. However, such an elastic coupling configuration represents a system which is capable of a vibration, whereby the vibration of the drive shaft can interfere with its own positioning of the rotor configuration with reference to the stator configuration.

### SUMMARY OF THE INVENTION

It is therefore the task of the invention to create a drive train of the mentioned art which is not sensitive to induced vibrations and to a bending of the drive shaft.

This task is solved through a drive train in which the second rotor part is pivotable supported through an enclosure mounted rotor bearing and is adjusted with reference to the stator.

Thus, the second rotor part is fixedly positioned through the proposed rotor bearing with reference to the stator, which reduces the effect of vibrations in the electric motor and, due to the tiltable coupling of the two rotor parts, tilting of the drive shaft has no effect on the second rotor part and its bearing whereby, at the same time, torque transfer between the rotor parts is possible. Thus, the presented drive train is hereby mostly insensitive with regard to vibration and with regard to bending of the drive shaft.

The first and the second rotor part are basically not to be understood exclusively as parts which are, designed as one piece. In fact, the first and/or the second rotor part can be designed as having several parts which are directly linked together through connections such as with screws welding, or riveted joints.

The drive train preferably has, beside the electric motor, an electric or thermodynamic operated drive motor, through which the drive train can be operated with two redundant drive systems, or in the sense of a hybrid drive train. A thermo dynamic driven engine can be understood as each kind of motor which generates kinetic energy or torque by using thermo dynamic effects, for instance an Otto motor or a diesel engine, or a combination of both, or a steam or gas turbine. An electric driven engine or the electric motor can be hereby any kind of motor which uses electromagnetic effects to generate kinetic energy or torque. Thus, the electric drive engine or the electric motor can be designed for instance as three-phase current, alternating current or stepper motors. It needs to be pointed out that the electric motor is preferably operated as either a motor or a generator, and the drive train can receive kinetic energy through the electric motor, but can also, in a recapturing mode, deliver kinetic energy and transfer it to an energy storage device for later use during a drive operation.

A clutch can hereby be provided between the driving motor and the drive shaft, preferably a starting clutch, which transfers, in an engaged mode, torque of the driving motor to the drive shaft, and does not transfer a torque from the driving motor to the drive shaft during the disengagement mode, whereby the driving motor can be separated from the remainder of the drive train. Alternatively, the driving motor can also be coupled directly with the drive shaft, for instance when a crankshaft of a combustion engine type operated driving motor this directly coupled with the drive shaft or are designed as one piece with the drive shaft.

In a preferred embodiment of the invention, a torsion vibration damper is positioned in the rotor of the electric motor which reduces non-uniform rotations or torque peaks of the electric motor, before they are transferred to the drive shaft, or which reduces non-uniform rotations or torque peaks of the drive shaft before they are transferred to the electric motor. In both cases, the result is a reduction of the mechanical load of the drive train, whereby its life expectancy is increased in a positive way.

In additional, advantageous embodiments of the invention, the two rotor parts are at least coupled through a connecting element, an additional connecting element, a flex plate, a gearing or an elastic rubber part.

### BRIEF DESCRIPTION OF THE DRAWINGS

In the following, the invention is further explained based on drawings which show additional, advantageous embodiments. The drawings each show in a schematic presentation:

FIG. 1 is a drive train in which a driving motor is coupled, via a clutch, with the drive shaft, whereby the drive shaft serves as the input shaft of a transmission, as a type of countershaft transmission, and the rotor parts are coupled with each other, via connecting elements;

FIG. 2 is a front view of the coupling of the rotor parts as in FIG. 1;

FIG. 3 is a front view of the coupling of a first rotor part and a second rotor part through a gearing;

FIG. 4 is the drive train, as in FIG. 1, with a bent drive shaft;

FIG. 5 is a drive train with a two part rotor where its rotor parts can be coupled, via a connecting element in accordance with FIG. 2, and via additional coupling elements;

FIG. 6 is a front view of a coupling of the first and the second rotor parts as in FIG. 5;

FIG. 7 is a drive train with a two part rotor, where the rotor parts are coupled via a flex plate;

FIG. 8 is a drive train in which a driving motor is directly coupled with a drive shaft, and a rotor of an electric motor has a torsion vibration damper.

### DETAILED DESCRIPTION OF THE PREFERRED EMBODIMENTS

In FIG. 1, the driving motor 1 is coupled with the drive shaft 3 via a clutch 2, which serves as a friction starting clutch. Thus, in the engaged condition of the clutch 2, the torque which is generated by the driving motor 1 is transferred through a motor output shaft 4, via the clutch 2, to the drive shaft 3 of the drive train. In the disengaged condition, however, torque cannot be transferred, via the clutch 2, from the driving motor 1 to the drive shaft 3. The drive shaft 3 is rotatably supported by two enclosure fixed shaft bearings 5A, 5B, and serves as an input shaft of a transmission 6, a type of a countershaft transmission, a reason for having a gear wheel 7 fixedly supported on the drive shaft 3, which gear wheel 7 transfers torque from the drive shaft 3 to a gear wheel 8 of a lay shaft 9 of the transmission 6.

An electric machine 10, which is positioned around the drive shaft 3, has an enclosure mounted stator 11 and a two part rotor 12. The first rotor part 12A is at least fixedly connected directly with the drive shaft 3; and the second rotor part 12B is directly driven by the stator 11 and pivotally supported by an enclosure-fixed rotor bearing 13, end fixed in its position with reference to the stator 11. Thus, the second rotor part 12B, depending on the type of the applied electric motor 10, has permanent magnets, coils or electric conductors which, together with the stator 11, directly drive the second rotor part 12B. The rotor bearing 13 and the shaft bearings 5A, 5B can be arbitrarily chosen; plain bearings or rolling bearings, which can be used in a floating X-, O- or a fixed-loose-configuration, are preferred. The coupling of the first rotor part 12A with the drive shaft 3 can be arbitrarily designed, but it needs to be capable of the torque transfer, for instance through known shaft-hub connections. Because of cost reasons, it is a particular advantage to have the first rotor part 12A firmly bonded or friction-proof coupled with the drive shaft 3. Also, the first rotor part 12A can be designed as a single component part with the drive shaft 3, whereby the drive shaft 3 and the first rotor part 12A can be manufactured in a common manufacturing process, such as through die forging, at an attractive cost.

The rotor parts 12A, 12B in FIG. 1 can be tilted against each other and can transfer the torque through cylinder-shaped connecting elements 14, one of which is shown in more detail in FIG. 2. FIG. 2 is a front view of the area which is marked by the dashed line circle in FIG. 1.

FIG. 2 shows an outer perimeter of the first rotor part 12A, which is positioned opposite to an inner perimeter of the second rotor part 12B. A play exists between the inner perimeter and the outer perimeter which allows a limited tilting of the first rotor part 12A with reference to the second rotor part 12B and a shifting of the first rotor part 12A with reference to the second rotor part 12B along the drawing plane. At its outer perimeter the first rotor part 12A has a first recess 15A, which is opposite to a second recess 15B of the second rotor part 12B at its inner perimeter. The connecting element 14 extends into the recesses 15A and 15B, which has a play with reference to the recesses 15A, 15B. To keep the connecting element 14 from not falling out of the recesses 15A, 15B, they also have additional disk-shaped ends 16, which overlap the recesses 15A, 15B. Due to the play of the connecting element 14 in the recesses 15A, 15B, the rotor parts 12A, 12B can continue to tilt with reference to each other and can be shifted along the drawing plane. In principle, it is sufficient if the connecting element 14 just has play with reference to the opposite recesses 15A, 15B, thus, it can therefore also be fixedly connected with one of the rotor parts 12A, 12B; for instance, it can be pressed into one of the recesses 15A, 15B.

During a relative motion of the second rotor part 12B with reference to the first rotor part 12A, for instance, if the electric motor 10 creates torque and rotation to drive the drive train, the second rotor part 12B is concentrically or nearly concentrically rotated with reference to the first rotor part 12A, whereby the connecting elements 14 attach themselves at a flank of the recess 15A of the first rotor part 12A and attach themselves, at point symmetrical to it, to a flank of the recess 15B of the second rotor part 12B; through which a torque transfer between the rotor parts 12A, 12B, by means of the connecting element 14, becomes possible. Accordingly, torque which is created by the drive shaft 3 can be transferred to the second rotor part 12B, especially for a generator mode operation of the electric motor 10. The play between the rotor parts 12A, 12B, and also between the connecting element 14 and the recesses 15A, 15B, shall be selected in a way so that under a maximum tilt of the first rotor part 12A with reference to the second rotor part 12B, and when operating the drive train, the rotor parts 12A, 12B do not immediately attach to each other, and that the connecting element 14 does not get clamped by itself, through a mutual tilting of the rotor parts 12A, 12B, in the recesses 15A, 15B.

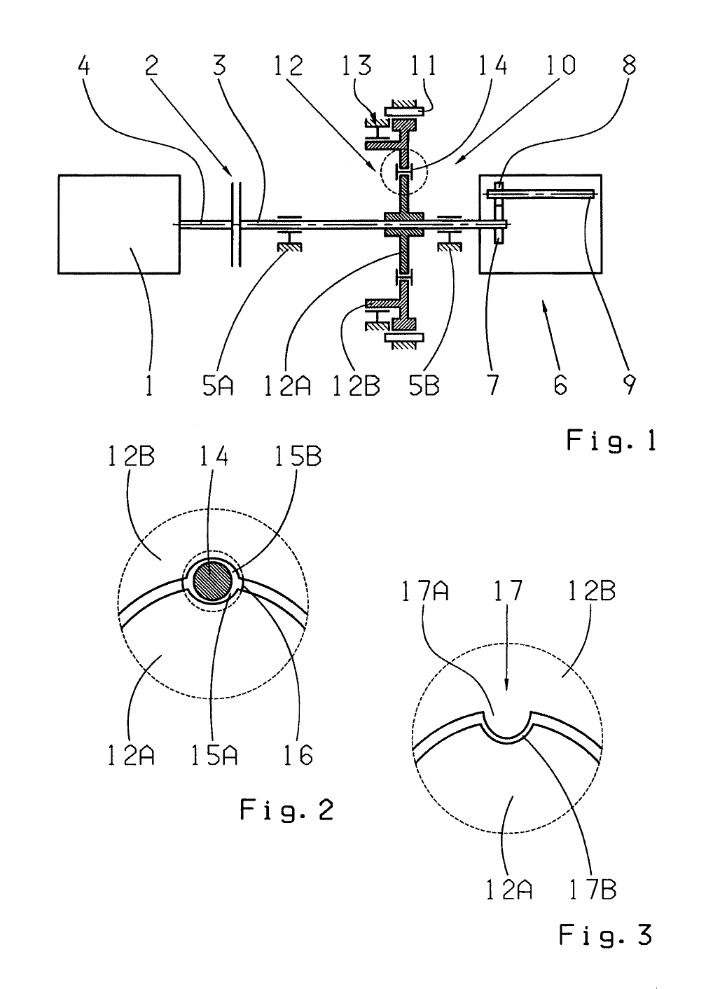

FIG. 3 shows the same area of the drive train, as in FIG. 2, but differs with reference to the drive train of FIG. 1 and FIG. 2 in that the first and second rotor part 12A, 12B are coupled with each other through a gearing 17, which has a play. The second rotor part 12B has a tooth, at its inner perimeter, which meshes with a trough 17B at the outer perimeter of the first rotor part 12A, with certain play. Any desired teeth 17A and troughs 17B in the rotor parts 12A, 12B can be meshingly positioned, and it is clear for a skilled person that the play of the two rotor parts 12A, 12B and the gearing 17 have to have dimensions in a way so that the rotor parts 12A, 12B, at the condition of a maximum tilt of the first rotor part 12A with reference to the second rotor part 12B, and when operating the drive train, only mesh directly via the gearing 17. The shape of the tooth 17A, or the shape of the trough 17B, respectively, can hereby chosen arbitrarily, for instance, they can have shapes such as a trapezoidal, evolvent, conchoidal or cycloidal shape.

In a preferred enhancement of the embodiments in accordance with FIG. 2 and FIG. 3, an elastic element, preferably an elastically damping element, is positioned between the two rotor parts 12A, 12B, which at least partially compensates for the play. In a preferred embodiment, the transfer of torque in a relative pivoting between the rotor parts 12A, 12B is not jerky anymore, from the point of time when the two rotor parts 12A, 12B collide, or when the rotor parts 12A, 12B collide with the connecting element 14, respectively; but the transfer of torque is continuous because the elastic element absorbs and/or damps the collision. It is especially preferred when the element fits the form of the two rotor parts 12A, 12B because torque transfer between the rotor parts 12A, 12B is immediately initiated at the point of time of the relative pivoting of the rotor parts 12A, 12B. The elastic element can, for instance, be placed between the rotor parts 12A, 12B through an injection molding process. It can especially be positioned as a sleeve around the connecting element 14, whereby it at least partially fills the play between the connecting element 14 and the two rotor parts 12A, 12B.

It is especially preferred that the element comprise a rubber or a kind of rubber material, such as a synthetic rubber for instance.

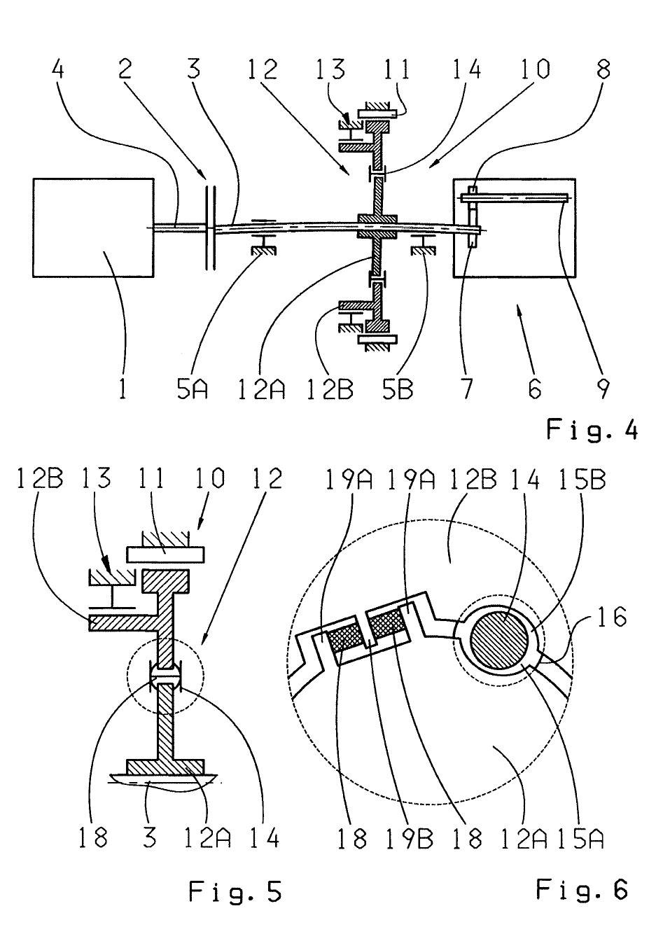

FIG. 4 shows the drive train of FIG. 1 in an operating mode, in which the drive shaft 3 is bent. The driving motor 1 and/or of the electric motor 10 transfer torque to the drive shaft 3 which again then transfers the torque, via the gear wheels 7, 8, to the lay shaft 9 of the transmission 6. During the transfer of torque from the gear wheels 7 of the drive shaft 3 to the gear wheel 8 of the lay shaft 9, a force is generated which drives the gear wheels 7, 8 apart. This force creates bending of the drive shaft 3, whereby no bending amplitude is present on the two shaft bearings 5A, 5B because of the fixed enclosure support. Due to the bending of the drive shaft 3, the first rotor part 12A, which is directly coupled with it, is now tilted with reference to the second rotor part 12B; but just an insignificant tilting force is applied due to the tiltable coupling of the two rotor parts 12A, 12B. Thus, the rotor bearing 13 of the second rotor part 12B is not additionally strained at the second rotor part 12B, and remains adjusted with reference to the stator 11. Possible vibrations which can occur in the drive train, due to the fixed positioning of the second rotor part 12B with reference to the stator 11, do not have any negative impact on the electric motor 10. During the tilting of the rotor parts 12A, 12B and their torque transferring coupling, an uninterrupted operation of the electric motor 10 is therefore possible in the sense of operating as a motor or as a generator.

FIG. 5 shows a half cut section of a drive train with the rotor bearing 13, the drive shaft 3, and the electric motor 10, comprising the stator 11 and the rotor 12, with the two rotor parts 12A, 12B; whereby the first rotor part 12A is coupled with the second rotor part 12B via the connecting elements 14, as shown in FIG. 6, and which are tiltably coupled through additional connecting parts 18, and which can transfer torque.

FIG. 6 hereby shows a front view of an area which is marked by the dashed line in FIG. 5, in which a connecting element 14 and two additional connecting elements 18 are positioned. By means of the additional connecting elements 18, positioned between the rotor parts 12A, 12B, relative rotation between the rotor parts 12A, 12B is damped or absorbed, dependent on the design of the additional connecting elements 18. The connecting element 14 and the recesses 15A, 15B correspond in position, form and function with the connecting element 14 and the recesses 15A, 15B of the FIG. 2. If necessary, the connecting elements 14 can also be omitted, so that the rotor parts 12A, 12B are exclusively, tiltably coupled with reference to each other and can transfer torque via the additional connecting elements 18.

In accordance with FIG. 6, the first rotor part 12A has at least two lug-form shapes 19A, between which another lug-form shape 19B of the second rotor part 12B extends into. The additional connecting elements 18 are operationally positioned between the shapes 19A, 19B in the direction of the perimeter, touching the sides of the shapes 19A, 19B of the rotor parts 12A, 12B. During relative rotation of the rotor parts 12A, 12B, for instance caused by a rotation of the drive shaft 3 and the first rotor part 12A with reference to the second rotor part 12B, at least one of the additional connecting elements 18 is pressed together. The other additional connecting elements 18, however, are stretched, in accordance with the fact that the additional connecting elements 18 are firmly connected with the shapes 19A, 19B. In the case that the additional connecting elements 18 are hereby designed as damping elements, relative rotation of the rotor parts 12A, 12B is hereby damped or, if the additional connecting elements 18 are hereby designed as spring elements, relative rotation of the rotor parts 12A, 12B is absorbed by the spring. The additional connecting elements 18, as effective damping elements, can be especially designed as known hydraulic dampers; and when they are effective spring elements, the additional connecting elements 18 can be especially designed as screw pressure springs, ring springs or as disk spring. The additional connecting elements 18 can also be designed as combined spring-damping elements, for instance by combining hydraulic dampers with screw pressure springs or by using for the additional connecting elements 18 at least partially an elastic and damping rubber or an elastic and damping kind of rubber material, as for instance a synthetic rubber material. The additional connecting elements 18 act, when they are at least designed as spring elements, like a torsion spring which is positioned between the rotor parts 12A, 12B, which absorb deviations in rotation or torque peaks between the rotor parts 12A, 12B, and thus, in an advantageous way, reduce the part stress of the drive train. If, however, the additional connecting elements 18 are at least designed as stamping elements, then the additional connecting elements 18 react in the sense of a torsion vibration damper which dampens non-uniformity rotation or torque shocks between the two rotor parts 12A, 12B, and therefore also, in an advantageous manner, reduces the parts stress of the drive train. At least a spiral spring can also be positioned between the first and the second rotor part 12A, 12B, which functions in the sense of a rotation spring.

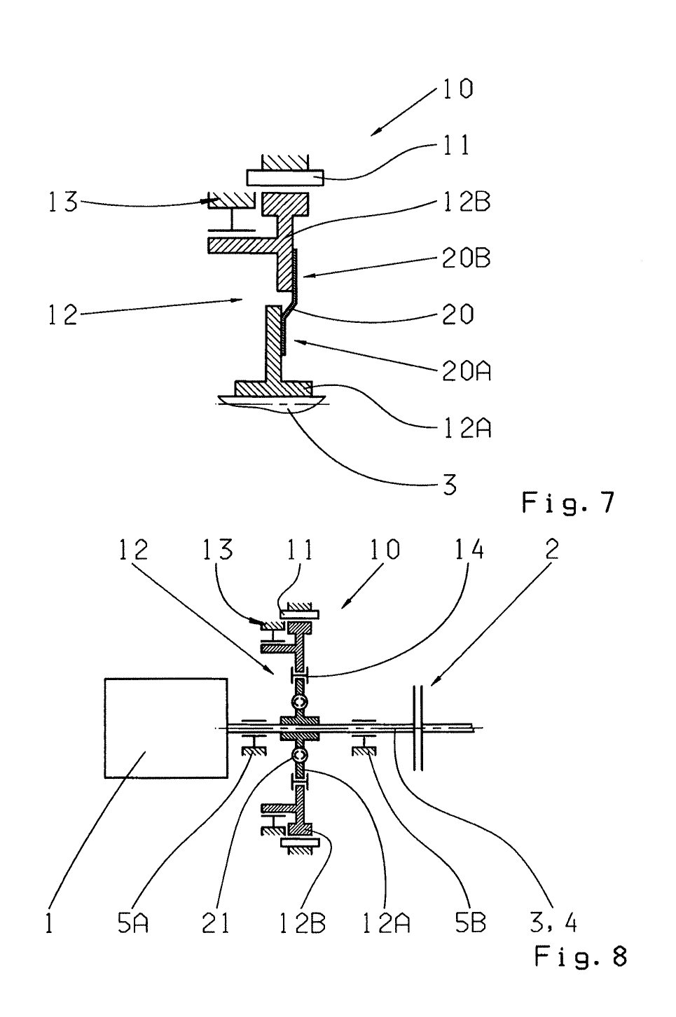

FIG. 7 shows the drive train in accordance with FIG. 5, whereby the two rotor parts 12A, 12B are coupled via a flex plate 20, instead of the connecting elements 14 and additional connecting elements 18. Such flex plates are known to compensate, for instance, axial offsets or an axle offset between a driving motor and a transmission in a motor vehicle drive train; whereby such a flex plate can transfer a driving motor torque moment to the transmission. Flex plates can be designed as a single part as well multiple parts. As shown in FIG. 7, the flex plate 20 is designed as a disc shaped single part; whereby it is at least fixedly connected at an impressed recess with the inner area 20A of the first rotor part 12A, and which is at least fixedly connected at an edge with the outer area 20B of the second rotor part 12B. The connection of the flex plate 20 with the rotor parts 12A, 12B can take place especially through screw connections, rivets or welding. During tilting of the drive shaft 3, and therefore tilting of the first rotor part 12A with reference to the second rotor part 12B, the inner area 20A of the flex plate 20 is also tilted, but the outer area 20B is fixed through the rotor bearing 13, which causes an elastic deformation of the flex plate 20. The elasticity of the flex plate 20 is determined in such a way that, during the tilting of the in the areas 20A with reference to the outer areas 20B, just very low tilting forces are transferred from the first rotor part 12A to the second rotor part 12B; whereby the rotor bearing 13 is just insignificantly stressed by the tilting of the first rotor part 12A with reference to the second rotor part 12B.

As an alternative to the flex plate 20, the first and the second rotor part 12A, 12B can also be coupled by means of a rubber elastic part, which is connected to the rotor parts 12A, 12B and which allows a tilting of the first rotor part 12A with reference to the second rotor part 12B and simultaneously also allows the ability to transfer torque. Such a rubber elastic part is preferably inserted through injection molding technique into a gap between the rotor parts 12A, 12B. Thus, it creates a ring which is positioned, for instance, between the outer perimeter of the first rotor part 12A and the inner perimeter of the second rotor part 12B. For better torque transfer between the rotor parts 12A, 12B and the rubber elastic part, the rotor parts 12A, 12B are preferably provided with a non-meshing gearing which is an almost by the rubber elastic part and is therefore connecting form-locking with the rotor parts 12A, 12B. The rubber elastic part has, compared to the connecting elements 14 and additional connecting elements 18, which are shown in FIG. 2, FIG. 3, and FIG. 6, the advantage that it can be easily manufactured through injection molding and be inserted between the rotor parts 12A, 12B. It also preferably comprises a rubber or a rubber like element, such as a synthetic rubber for instance.

The drive train as shown in FIG. 8, in accordance with the drive train in FIG. 4, has a driving motor 1 and the electric motor 10, comprising the stator 11 and the two rotor parts 12A, 12B of the rotor 12, where the second rotor part 12B, with the rotor bearing 13, is in a fixed position with reference to the stator 11. In addition, the drive train also has the drive shaft 3 with the shaft bearings 5A, 5B. Different from the drive train in FIG. 1, in the drive train shown here, the driving motor 1 is directly connected with the drive shaft 3, whereby the motor output shaft 4 of the driving motor 1 serves as the drive shaft 3. The clutch 2 is positioned on the output side after the electric motor 10, which enables separation of the driving motor 1, together with the electric motor 10, from the remainder of the drive train, not-shown. During disengagement of the clutch 2, the driving motor 1 can therefore exclusively be used to drive the electric motor 10, which then recovers the kinetic energy which is generated by the driving motor 1 and stores it in an energy storage such as a battery, not-shown. Alternatively, when the clutch 2 is disengaged, the electric machine can drive, preferably exclusively, the driving motor 1 during starting.

In FIG. 8, the first rotor part 12A has a torsion vibration damper 21, especially known from friction starting clutches or from DE 199 43 037 A1, which dampens torque peaks which are generated in the electric machine 10 during the operation of the drive train. Here, the first rotor part 12A comprises at least two halves, and the torsion vibration damper connects the two halves with each other.

An enhancement of the drive train as in FIG. 8, not shown, provides a design to couple the driving motor 1 and the drive shaft 3 with each other via a second clutch which would be positioned in the drive train in accordance with the clutch 2 of FIG. 1. Here, the remains of the drive train, on the output side after the electric motor 10, are only selectively driven by the driving motor 1 and dragging along the electric motor 10, whereby the clutch 2 and the second clutch are also engaged, or can be driven only by means of the electric motor 10, whereby the clutch 2 is disengaged and the second clutch is engaged.

FIG. 1 to FIG. 8 show each electric motors 10 with an inner rotor design, but it is clear for a skilled person in the art that the invention can be extended to electric machine 10 with the next on the rotor design. Especially in this case, the second rotor part 12B, with an embodiment of the invention in accordance with FIG. 2, FIG. 3, or FIG. 6, can have, instead of an inner perimeter configuration, in accordance with the first rotor part 12A shown in there, also an outer perimeter configuration. Thus, the first rotor part 12A in an embodiment of the invention in accordance with FIG. 2, FIG. 3, or FIG. 6, can have, instead of the outer perimeter configuration shown in there, also an inner perimeter configuration, in accordance with the second rotor part 12B which is shown in there.

### REFERENCE CHARACTERS

1 Driving Motor
2 Clutch
3 Drive Shaft
4 Motor Output Shaft
5A Shaft Bearing
5B Shaft bearing
6 Transmission
7 Gear Wheel
8 Gear Wheel
9 Lay Shaft
10 Electric Motor
11 Stator
12 Rotor
12A First Rotor Part
12B Second Rotor Part
13 Rotor Bearing
14 Connecting Element
15A First Recess
15B Second Recess
16 End of the Connecting Element 14
17 Gearing
17A Tooth
17B Trough
18 Another Connecting Element
19A Shape
19B Additional Shape
20 Flex Plate
20A Inner Area of the Flex Plate 20
20B Outer Area of the Flex Plate 20
21 Torsion Vibration Damper

1-12. (canceled)

13. A drive train for a motor vehicle which has at least:
a rotatable drive shaft (3),
an electric or thermo dynamic driven driving motor (1) which can be driven by the drive shaft (3), and
comprises of an electric motor (10) which has an enclosure mounted stator (11) and a rotatable rotor (12) which is coupled with the drive shaft (3),
wherein the rotor (12) comprises at least first and second rotor parts (12A, 12B) and the first rotor part (12A) is directly coupled with the drive shaft (3) and the a second rotor part (12B) is directly driven via the stator (11), and the first rotor part (12A) is tiltable to each other coupled with the second rotor part (12B) for a torque transfer, and the second rotor part (12B) is supported by an enclosure mounted rotor bearing (13) and is aligned with reference to the stator (11).

14. The drive train according to claim 13, wherein the drive train has a clutch (2) which is positioned between the driving motor (1) and the drive shaft (3) and, in an engaged condition of the clutch (2), torque from the driving motor (1) is transferred to the drive shaft (3) via the clutch (2).

15. The drive train according to claim 14, wherein the driving motor (1) is directly coupled with the drive shaft (3).

16. The drive train according to claim 13, wherein the first rotor part (12A) is one of firmly bonded or force-connected with the drive shaft (3) or is formed integral as one-piece with the drive shaft (3).

17. The drive train according to claim 13, wherein one of the first and the second rotor parts (12A, 12B) has at least a recess (15A, 15B), on an outer perimeter thereof, and that the other of the first and the second rotor parts (12A, 12B) has at least mating recess (15A, 15B), and whereby a connecting element (14) extends into at least one of the recesses (15A, 15B) which has play.

18. The drive train according to claim 13, wherein the first rotor part (12A) and the second rotor part (12B) are coupled with one other via a gearing (17) which has play.

19. The drive train according to claim 17, wherein the play is at least partially filled with an elastic element.

20. The drive train according to claim 13, wherein the rotor (12) includes a torsion vibration damper (21).

21. The drive train according to claim 13, wherein a rotation spring is positioned between the first and the second rotor parts (12A, 12B).

22. The drive train according to claim 13, wherein at least one flex plate (20) is positioned between the first rotor part (12A) and the second rotor part (12B), each at least one flex plate (20) is torque proof coupled with at least one of the first and the second rotor parts (12A, 12B).

23. The drive train according to claim 13, wherein the first and the second rotor parts (12A, 12B) are coupled at least via a rubber-elastic part.
